(19) United States
(12) Patent Application Publication
(10) Pub. No.: US 2016/0229348 A1
(43) Pub. Date: Aug. 11, 2016

(54) INTERIOR TRIM ASSEMBLY FOR A VEHICLE

(71) Applicant: FORD GLOBAL TECHNOLOGIES, LLC, Dearborn, MI (US)

(72) Inventors: Iskander Farooq, Novi, MI (US); Dean M. Jaradi, Macomb, MI (US); Mohammed Omar Faruque, Ann Arbor, MI (US)

(21) Appl. No.: 14/617,978

(22) Filed: Feb. 10, 2015

(51) Int. Cl. B60R 7/04; B60N 3/10; B60N 2/46; B62D 21/15

(52) U.S. Cl. CPC B60R 7/046; B62D 21/157; B60N 3/10; B60N 2/4633

(57) ABSTRACT

An interior trim assembly includes a door trim substrate, a compartment supported by the door trim substrate, and an armrest connected by a hinge along an edge to an inner side wall of the compartment. The compartment includes the inner side wall, and end walls, and supports at least one sub-compartment for storing items therein. At least one of the inner side wall, the end walls, and the at least one lidded sub-compartment for storing items therein is reinforced to absorb a force caused by a side impact to the vehicle. The at least one sub-compartment for storing items therein includes a lid and may support a cup holder. The hinge includes a coil spring and is non-energized in a closed position. A latch may be used to secure the armrest in the closed position.

### TECHNICAL FIELD

This document relates generally to trim assemblies for vehicle interiors, and more specifically to a multi-function armrest.

### BACKGROUND

It is known to provide automotive interiors with various trim assemblies to improve the aesthetic appearance of the automotive interior and for the comfort and convenience of vehicle passengers. Examples of such interior trim assemblies include the instrument panels, armrests, door trim panels, and consoles. In many of these, various storage areas are incorporated therein that allow the vehicle occupant to conveniently store one or more items, such as maps, glasses, tire gauges, coins, and other items typically carried in a vehicle. In many cases, such as for storage compartments in door panels, it is desirable for the compartment to include a door or cover that overlies the opening and secures the items within the compartment. The cover is typically attached to the compartment and moveable, such as by a hinge mechanism, so that the articles in the compartment may be accessed. Moreover, the cover may be supported by additional padding and provide an armrest for the door panel.

Such storage compartments in door panels, including beneath an armrest, however, have typically only provided a large singular storage space in the area where a core structure that supports the weight of the passenger's arm at rest and has sufficient stiffness beneficial for side or pole impact events typically resides. Accordingly, a need exists for a multi-purpose storage area positioned beneath an armrest. The storage area should provide multiple sub-compartments including lidded and unlidded sub-compartments, cup-holders, and possibly change holders and/or electronic ports for connecting hand-held devices to the audio system or charging such devices. Such a storage area should also account for the loss of the traditional core structure and include elements which are reinforced to absorb a force caused by a side or pole impact to the vehicle. These elements could include any combination of walls/floors of the compartment and sub-compartments, and may include use of corrugated plastics and various metal or plastic brackets to absorb the forces.

### SUMMARY OF THE INVENTION

In accordance with the purposes and benefits described herein, an interior trim assembly for a vehicle is provided. The interior trim assembly may be broadly described as comprising a door trim substrate, a compartment supported by the door trim substrate, the compartment comprising an inner side wall, and end walls, and supporting at least one lidded sub-compartment for storing items therein, and an armrest connected by a hinge along an edge to the inner side wall of the compartment.

In one possible embodiment, the hinge includes a coil spring. In another, the coil spring is selected such that the spring is non-energized in a closed position.

In one other possible embodiment, the automotive interior trim assembly further includes a latch for securing the armrest in a closed position.

In another possible embodiment, the hinge allows the armrest to open to an open position more than 180 degrees from a closed position.

In still another possible embodiment, the compartment further supports a cup holder positioned within the compartment.

In one other possible embodiment, at least one of the inner side wall, the end walls, and the at least one lidded sub-compartment for storing items therein is reinforced to absorb a force caused by a side impact to the vehicle.

In yet another possible embodiment, at least one of the door trim substrate and the compartment are attached to a door of the vehicle, if not both.

In accordance with another possible embodiment, an interior trim assembly for a vehicle includes a door trim substrate, a compartment attached to the door trim substrate, the compartment comprising an inner side wall, end walls, and a floor, and supporting at least one sub-compartment for storing items therein, and an armrest hingedly connected to the inner side wall of the compartment, wherein at least one of the inner side wall, the end walls, and the floor are reinforced to absorb a force caused by a side impact to the vehicle.

In one possible embodiment, the at least one sub-compartment for storing items therein includes a lid.

In another possible embodiment, the hinge includes a coil spring. In another, the coil spring is non-energized in a closed position.

In yet another possible embodiment, the automotive interior trim assembly further includes a latch for securing the armrest in the closed position.

In still another possible embodiment, the hinge compartment is attached to a door of the vehicle.

In accordance with another possible embodiment, an interior trim assembly for a vehicle includes a door trim substrate, a compartment attached to the door trim substrate, the compartment comprising an inner side wall, and end walls, and supporting a sub-compartment comprising at least one lidded sub-compartment for storing items therein and a cup holder, and an armrest connected to the compartment by a coil spring hinge along an edge of the compartment.

In another possible embodiment, the at least one lidded sub-compartment for storing items therein includes side walls, end walls, and a floor, and at least one of the end walls and the floor are reinforced to absorb a force caused by a side impact to the vehicle. In another, the coil spring is non-energized in a closed position. In still another, the interior trim assembly further comprises a latch for securing the armrest in the closed position.

A vehicle incorporating any of the interior trim assemblies for a vehicle described above.

In the following description, there are shown and described several preferred embodiments of the interior trim assemblies for a vehicle. As it should be realized, the assemblies are capable of other, different embodiments and their several details are capable of modification in various, obvious aspects all without departing from the assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the interior trim assembly for an vehicle and together with the description serve to explain certain principles thereof. In the drawing figures:

FIG. 1 is a partial perspective view of a typical vehicle door assembly showing an arm rest in a closed position;

FIG. 2 is a partial perspective view of a typical vehicle door assembly showing the arm rest in an open position providing access to a compartment;

FIG. 3 is a partial perspective view of a compartment showing lidded sub-compartments, a sub-compartment, and a cup holder positioned therein;

FIG. 4 is a partial perspective view of an alternate removeable compartment having lidded sub-compartments, a sub-compartment, and a cup holder; and

FIG. 5 is a partial perspective view of the compartment showing lidded sub-compartments, a sub-compartment, and a cup holder, and an armrest supported in an open position by a hinge.

Reference will now be made in detail to the present preferred embodiments of the interior trim assemblies for a vehicle, examples of which are illustrated in the accompanying drawing figures, wherein like numerals are used to represent like elements.

### DETAILED DESCRIPTION

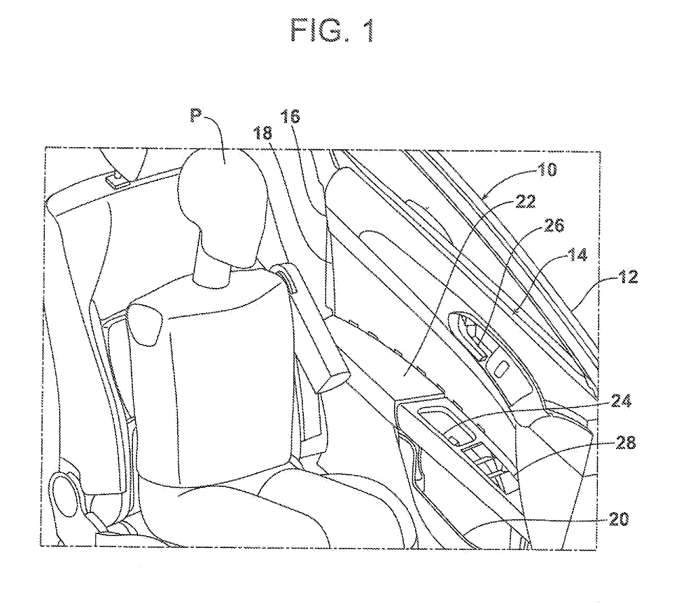

Reference is now made to FIG. 1 which illustrates a typical door assembly 10 of a vehicle (not shown). The door assembly 10 includes a door 12 and an interior trim assembly 14 which covers a portion of the interior of the vehicle to provide an aesthetically pleasing appearance and additional comfort to the vehicle's passengers. While the described interior trim assembly is for a front door assembly, those having ordinary skill in the art will recognize that the interior trim assembly may be used in association with other vehicle doors, for example, a rear door or a third row door.

The interior trim assembly 14 includes a door trim substrate 16 which generally defines the shape of the interior trim assembly. The door trim substrate 16 may be a plastic, rigid or semi-rigid, or other materials such as a composite material. Portions of the door trim substrate 16, for example panel 18, may be made of a decorative fabric, a plastic having a wood grain, wood trim, or other materials known in the art. In the present described embodiment, the door trim substrate 16 is a molded plastic that supports a pocket 20 for receiving books, maps, etc., an armrest 22 for supporting a forearm of a passenger (P) and providing the noted additional comfort to the vehicle's passenger (P), a door grip 24, a door release lever 26, and various electrical controls 28.

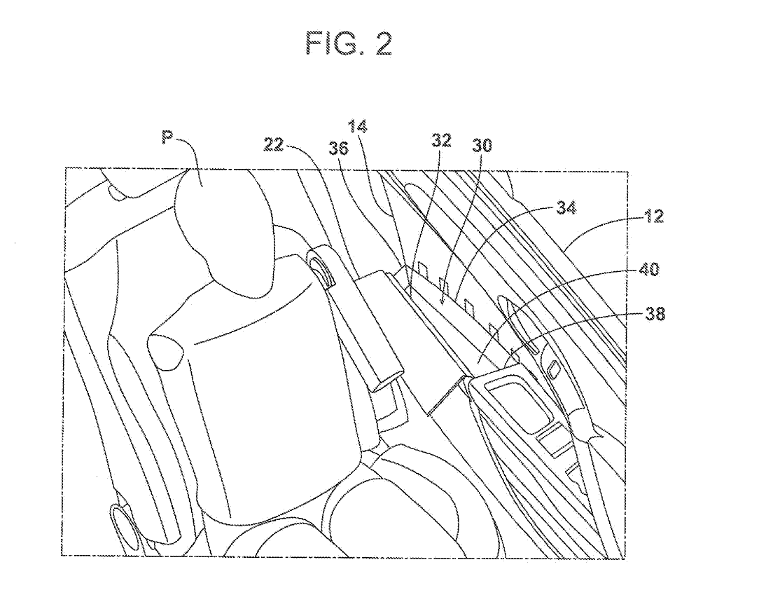

As shown in FIG. 2, the door trim substrate 16 also supports a compartment 30. Armrest 22 serves as a lid for the compartment 30 which includes an inner side wall 32 adjacent the passenger (P), an outer side wall 34, end walls 36, 38, and a floor 40. Although not shown, the compartment 30 may be attached directly to the door 12 or to brackets attached to the door to provide additional support beyond that provided by the door trim substrate 16.

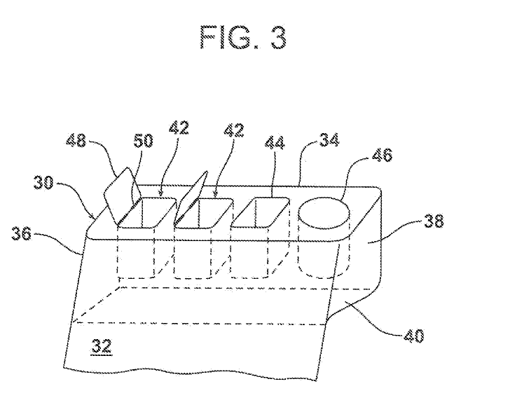

As shown in FIG. 3, the inner side wall 32 of the compartment 30 may be integrally formed and extend below the floor 40. Alternatively, the inner side wall may extend only to the floor 40. As shown, the compartment 30 includes two lidded sub-compartments 42, a sub-compartment 44, and a cup holder 46. Other arrangements may include any combination of one or more lidded sub-compartments, one or more sub-compartments, and/or one or more cup holders.

The lidded sub-compartments 42 necessarily include a lid 48 hingedly connected thereto. The hinge 50 may be a living hinge integrally molded with the sub-compartment 42 or, as shown in the described embodiment, a hinge. The hinge 50 may be spring loaded or otherwise. The lid 48 may be connected to the sub-compartment 42 along a rear edge as shown, or along any of the four upper edges of the sub-compartment.

In the described embodiment, the armrest 22 is capable of moving to a closed position as shown in FIG. 1. In this closed position, the two lidded sub-compartments 42, sub-compartment 44, and cup holder 46 are enclosed within the compartment 30. In other words, when the lids 48 of the two lidded sub-compartments 42 are in the closed position, the armrest 22 itself is able to be moved to a closed position without interference from any of the items positioned inside the compartment 30.

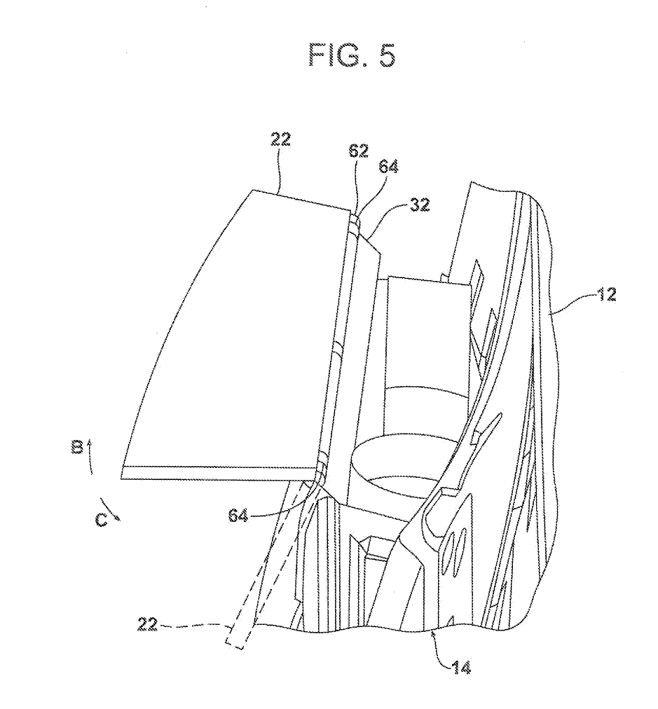

A latch (not shown) secures the armrest 22 in the closed position (shown in FIG. 1). As shown in FIG. 5, the armrest 22 may be moved to an open position by pressing down on the armrest which releases the latch and allows the armrest to rotate about a hinge 62 providing access to the compartment 30. Similarly, to move the armrest from the open position to the closed position, the passenger (P) may rotate the armrest 22 (as shown by action arrow B) to a position adjacent the closed position. Pressing down on the armrest 22 further causes the latch to capture the armrest in the closed position. Other latching and/or locking mechanisms may be utilized in alternate embodiments to secure the armrest in the closed position and release the armrest for movement to an open position.

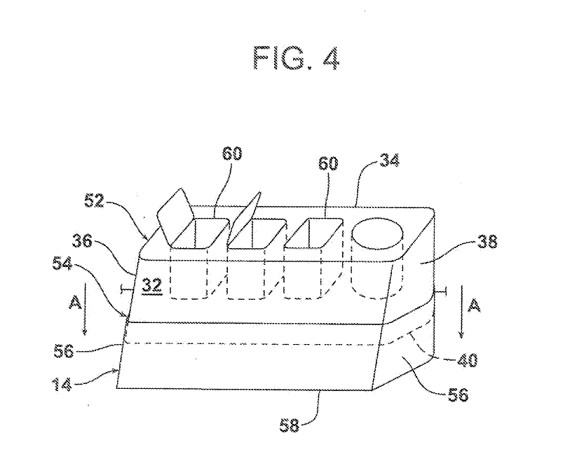

In an alternate described embodiment shown in FIG. 4, a compartment 52 may be removeably supported by the interior trim assembly 14. As shown by action arrows A, the compartment 52 may be inserted within a cavity, generally designed numeral 54, formed in the interior trim assembly 14. The compartment 52 may be supported by the interior trim assembly 14 by clips or fasteners (not shown) and/or may be attached directly to the door 12.

In both embodiments, the compartments 30, 52 may include elements which are reinforced to absorb a force caused by a side impact to the vehicle. More specifically, any combination of the inner side wall 32, the outer side wall 34, the end walls 36, 38, and/or the floor 40 may be reinforced as desired. Even more, walls 56 or floor 58 of the cavity 54 formed in the interior trim assembly 14, and side walls 60 of the sub-compartments may be likewise reinforced. Reinforcement beneath an armrest in a typical door assembly may include use of corrugated plastics and various metal or plastic brackets to absorb the forces associated with a side impact, such as a pole impact, to the vehicle. Since the space where such reinforced materials are typically located is utilized in accordance with the present invention, by a compartment 30 or 52, reinforcing materials, if used, must be positioned elsewhere. As noted above, these reinforcing materials may be utilized in various ways within the components of the compartment 30 or 52.

As noted above, the interior trim assembly 16 supports a compartment 30. As shown in FIG. 5, the armrest 22 serves as a lid for the compartment 30 in addition to its primary function of supporting a forearm of the passenger (P). The armrest 22 is connected to the inner side wall 32 of the compartment 30 by a hinge 62. In the described embodiment, the hinge 62 includes spring coils 64 which are non-energized in the closed position. In other words, the armrest 22 is biased by the spring coils 64 toward the closed position when the armrest is in the open position as shown.

In an alternate embodiment shown by dashed lines in FIG. 5, the hinge 62 may not include a spring coil allowing rotation of the armrest 22 from the closed position to an open position more than 180 degrees from the closed position, or a fully open position, wherein the armrest is essentially hanging adjacent the door trim substrate 16. In yet another embodiment, a stop (not shown) may be utilized to maintain the armrest 22 in an open position wherein the armrest is essentially horizontal. In this position, the armrest 22 may serve as a tray similar to a seat back tray of an airplane.

In summary, numerous benefits result from an interior trim assembly for a vehicle as illustrated in this document. The interior trim assembly is capable of providing additional, specific storage area beneath an armrest. The additional storage area may include various combinations of lidded and unlidded sub-compartments and cup holders. In addition, elements of the compartments 30, 52 may be reinforced to absorb a force caused by a side impact to the vehicle.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. An interior trim assembly for a vehicle, comprising:
a door trim substrate;
a compartment supported by said door trim substrate, said compartment comprising an inner side wall, and end walls, and supporting at least one lidded sub-compartment for storing items therein; and
an armrest connected by a hinge along an edge to said inner side wall of said compartment,
wherein at least one of said inner side wall, said end walls, and said at least one lidded sub-compartment for storing items therein is reinforced to absorb a force caused by a side impact to the vehicle.

2. The interior trim assembly for a vehicle of claim 1, wherein said hinge includes a coil spring.

3. The interior trim assembly for a vehicle of claim 2, wherein said coil spring is non-energized in a closed position.

4. The interior trim assembly for a vehicle of claim 3, further comprising a latch for securing said armrest in a closed position.

5. The interior trim assembly for a vehicle of claim 1, wherein said hinge allows said armrest to open to an open position more than 180 degrees from a closed position.

6. The interior trim assembly for a vehicle of claim 1, wherein said compartment further supports a cup holder positioned within said compartment.

7. (canceled)

8. A vehicle incorporating the interior trim assembly for a vehicle of claim 1 wherein at least one of said door trim substrate and said compartment are attached to a door of said vehicle.

9. An interior trim assembly for a vehicle, comprising:
a door trim substrate;
a compartment attached to said door trim substrate, said compartment comprising an inner side wall, end walls, and a floor, and supporting at least one sub-compartment for storing items therein; and
an armrest hingedly connected to said inner side wall of said compartment, wherein at least one of said inner side wall, said end walls, and said floor are reinforced to absorb a force caused by a side impact to the vehicle.

10. The interior trim assembly for a vehicle of claim 9, wherein said at least one sub-compartment for storing items therein includes a hinged lid.

11. The interior trim assembly for a vehicle of claim 9, wherein a hinge connecting said armrest and said inner side wall of said compartment includes a coil spring.

12. The interior trim assembly for a vehicle of claim 11, wherein said coil spring is non-energized in a closed position.

13. The interior trim assembly for a vehicle of claim 11, further comprising a latch for securing said armrest in a closed position.

14. The interior trim assembly for a vehicle of claim 9, wherein said compartment is attached to a door of said vehicle.

15. A vehicle incorporating the interior trim assembly for a vehicle of claim 9.

16. An interior trim assembly for a vehicle, comprising:
a door trim substrate;
a compartment attached to said door trim substrate, said compartment comprising an inner side wall, and end walls, and supporting a sub-compartment comprising at least one lidded sub-compartment for storing items therein and a cup holder; and
an armrest connected to said compartment by a coil spring hinge along an edge of said compartment,
wherein said at least one lidded sub-compartment for storing items therein includes side walls, end walls, and a floor, and at least one of said end walls and said floor are reinforced to absorb a force caused by a side impact to the vehicle.

17. (canceled)

18. The interior trim assembly for a vehicle of claim 16, wherein said coil spring is non-energized in a closed position.

19. The interior trim assembly for a vehicle of claim 18, further comprising a latch for securing said armrest in the closed position.

20. A vehicle incorporating the interior trim assembly for a vehicle of claim 19.
